(19) United States
(12) Patent Application Publication
(10) Pub. No.: US 2014/0189303 A1
(43) Pub. Date: Jul. 3, 2014

(54) MULTISTAGE MODULE EXPANSION SYSTEM AND MULTISTAGE MODULE COMMUNICATION METHOD

(71) Applicant: ASKEY COMPUTER CORP., New Taipei City (TW)

(72) Inventor: TENG-KUEI CHANG, NEW TAIPEI CITY (TW)

(73) Assignee: ASKEY COMPUTER CORP., NEW TAIPEI CITY (TW)

(21) Appl. No.: 13/760,108

(22) Filed: Feb. 6, 2013

(30) Foreign Application Priority Data
Dec. 28, 2012 (TW) 101150941

(51) Int. Cl. G06F 15/76

(52) U.S. Cl. CPC G06F 15/76
USPC 712/31

(57) ABSTRACT

A multistage module expansion system and multistage module communication method, applicable to a set-top box, are introduced. The system includes a master module, at least a preceding expansion module, and at least a succeeding expansion module. The master module generates and sends a control instruction to the preceding expansion module and the succeeding expansion module. The preceding expansion module and the succeeding expansion module each determine whether the control instruction is of a type executable by the preceding expansion module and the succeeding expansion module, respectively. If the determination is affirmative, the preceding expansion module creates and sends a preceding data packet to the master module, and the succeeding expansion module creates and sends a succeeding data packet to the preceding expansion module, such that the preceding expansion module sends the succeeding data packet to the master module.

### CROSS-REFERENCE TO RELATED APPLICATION

This non-provisional application claims priority under 35 U.S.C. §119(a) on Patent Application No(s). 101150941 filed in Taiwan, R.O.C. on Dec. 28, 2012, the entire contents of which are hereby incorporated by reference.

### FIELD OF TECHNOLOGY

The present invention relates to expansion systems and communication methods for use with expansion modules, and more particularly, to a multistage module expansion system and a multistage module communication method which are characterized by at least a preceding expansion module and at least a succeeding expansion module.

### BACKGROUND

According to the prior art, a set-top box receives digital video signals and performs demodulation, decompression, and digital-to-analog conversion on the received digital video signals to thereby provide video images to be watched by the audience.

Due to an increasingly large number of sources of digital information, conventional set-top boxes are opening up to plenty of applications, such as receiving digital broadcast signals, and decoding medium digital data stored in an external storage device.

In general, conventional set-top boxes each comprise therein one or more built-in expansion slots for optionally accommodating one or more expansion modules, such as a digital broadcast receipt expansion module. However, the aforesaid purpose of the built-in expansion slots is achieved at the expense of the cost efficiency and the miniaturization potential of the set-top boxes. Furthermore, set-top box manufacturers are deemed a determining factor in the cable specifications of the expansion slots, and thus consumer choice is restricted to those expansion modules which are dedicated to the cable specifications of the expansion slots.

Accordingly, it is imperative to provide a module expansion system and a module communication method which overcome the aforesaid drawbacks of the prior art.

### SUMMARY

It is an objective of the present invention to provide a multistage module expansion system characterized in that, upon series-connection of a preceding expansion module and a succeeding expansion module, both a preceding data packet generated from the preceding expansion module and a succeeding data packet generated from the succeeding expansion module are sent from the preceding expansion module to a master module, such that the master module receives the preceding data packet and the succeeding data packet via the preceding expansion module.

Another objective of the present invention is to send a control instruction generated from the master module to the preceding expansion module and succeeding expansion module by means of the multistage module expansion system, wherein the preceding expansion module determines whether the control instruction falls under a category of instructions executable by the preceding expansion module before determining whether to generate a preceding data packet in accordance with the control instruction, and the succeeding expansion module determines whether the control instruction falls under a category of instructions executable by the preceding expansion module before determining whether to generate a succeeding data packet in accordance with the control instruction, thereby allowing the master module to control the preceding expansion module and the succeeding expansion module with the control instruction.

Yet another objective of the present invention is to provide the multistage module expansion system characterized in that a plurality of expansion modules with a plurality of connection ends (such as a master end, a preceding end, a preceding expansion end, a succeeding end, and a succeeding expansion end which are defined hereunder) transmits a plurality of data packets, wherein the connection ends comply with a communication protocol (such as PCI-E and USB2.0/3.0) governing desirable bandwidths (such as bandwidths of 5 Gbps, 480 Mbps, or 4.8 Gbps), such that the transmission of the data packets can be performed well, regardless of whether the connection ends are series-connected or parallel-connected.

A further objective of the present invention is to provide a multistage module communication method whereby a control instruction generated from a master module can be transmitted from at least a preceding expansion module to at least a succeeding expansion module. After the at least a preceding expansion module and the at least a succeeding expansion module have received the control instruction, if the at least a preceding expansion module confirms that the control instruction falls under a preceding instruction category, the at least a preceding expansion module will generate a preceding data packet, and, if the at least a succeeding expansion module confirms that the control instruction falls under a succeeding instruction category, the at least a succeeding expansion module will generate a succeeding data packet. The preceding data packet is directly sent to the master module. The succeeding data packet is sent to the at least a preceding expansion module, and then the succeeding data packet is sent from the at least a preceding expansion module to the master module.

In order to achieve the above and other objectives, the present invention provides a multistage module expansion system comprising a master module, at least a preceding expansion module, and at least a succeeding expansion module. The master module has a master processing unit and a master end connected to the master processing unit. The master processing unit generates a control instruction and sends the control instruction to the master end. The at least a preceding expansion module has a preceding end, a preceding processing unit, and a preceding expansion end. The preceding end is connected to the master end, the preceding processing unit, and the preceding expansion end. The preceding processing unit determines whether the control instruction falls under a category of instructions executable by the preceding processing unit. In response to an affirmative determination, the preceding processing unit executes the control instruction and generates a preceding data packet, such that the preceding processing unit sends the preceding data packet from the preceding end to the master end. The at least a succeeding expansion module has a succeeding end and a succeeding processing unit. The succeeding end is connected to the succeeding processing unit and the preceding expansion end. The succeeding processing unit determines whether the control instruction falls under a category of instructions executable by the succeeding processing unit. In response to an affirmative determination, the succeeding processing unit executes the control instruction and generates a succeeding data packet, and the succeeding processing unit sends the succeeding data packet to the succeeding end, such that the succeeding data packet is sent to the master end via the preceding expansion end and the preceding end.

In order to achieve the above and other objectives, the present invention provides a multistage module communication method for transmitting a preceding data packet, a succeeding data packet, and a control instruction between a master module and at least a preceding expansion module and transmitting the succeeding data packet and the control instruction between the at least a preceding expansion module and at least a succeeding expansion module. The multistage module communication method comprises the steps of: (a) generating the control instruction by the master module, wherein the control instruction falls under a preceding instruction category executable by the preceding expansion module or a succeeding instruction category executable by the succeeding expansion module; (b) receiving the control instruction by the preceding expansion module, and receiving the control instruction by the succeeding expansion module through the preceding expansion module; (c) determining whether the control instruction falls under the preceding instruction category by the preceding expansion module and, upon affirmative determination, generating the preceding data packet by the preceding expansion module, and/or determining whether the control instruction falls under the succeeding instruction category and by the succeeding expansion module, upon affirmative determination, generating the succeeding data packet by the succeeding expansion module; and (d) sending at least one of the preceding data packet and the succeeding data packet from the preceding expansion module to the master module, wherein the succeeding expansion module sends the succeeding data packet to the preceding expansion module to thereby allow the preceding expansion module to send the succeeding data packet to the master module.

Compared with the prior art, the multistage module expansion system and the multistage module communication method of the present invention is characterized in that: given the function-limited expansion connection end of a conventional set-top box, the quantity of expansion modules connected in series and/or connected in parallel is not limited by the quantity of the expansion connection ends.

Furthermore, the set-top box can give control instructions to the expansion modules such that, after one of the expansion modules has received a control instruction that falls under a category of instructions executable by the expansion module itself, the expansion module generates a data packet in accordance with the control instruction. According to the present invention, each of the expansion modules not only receives a control instruction and generates a data packet in accordance with the control instruction received, but also functions as an intermediate media whereby another said expansion module transmits the control instruction and the data packet.

### BRIEF DESCRIPTION OF THE DRAWINGS

Objectives, features, and advantages of the present invention are hereunder illustrated with specific embodiments in conjunction with the accompanying drawings, in which:

FIG. 1 is a block diagram of a multistage module expansion system according to the first embodiment of the present invention;

FIG. 2 is a schematic view of the structure of a preceding data packet and a succeeding data packet which are depicted in FIG. 1;

FIG. 3 is a block diagram of the multistage module expansion system according to the second embodiment of the present invention;

FIG. 4 is a block diagram of the multistage module expansion system according to the third embodiment of the present invention; and

FIG. 5 is a flow chart of a multistage module communication method according to an embodiment of the present invention.

### DETAILED DESCRIPTION

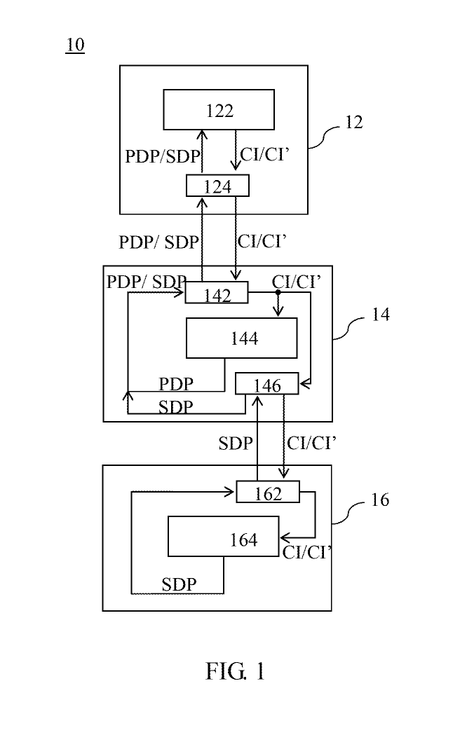

Referring to FIG. 1, there is shown a block diagram of a multistage module expansion system according to the first embodiment of the present invention. As shown in FIG. 1, a multistage module expansion system 10 comprises a master module 12, a preceding expansion module 14, and a succeeding expansion module 16

The master module 12 comprises a master processing unit 122 and a master end 124. The master processing unit 122 and the master end 124 are connected. The master processing unit 122 of the master module 12 generates a control instruction CI. The master end 124 of the master module 12 receives the control instruction CI. The control instructions CI are of two categories, namely those control instructions CI which are executable by the preceding expansion module 14 (hereinafter referred to as “preceding instruction category”,) and those control instructions CI which are executable by the succeeding expansion module 16 (hereinafter referred to as “succeeding instruction category”.) For instance, after the preceding expansion module 14 has received the control instruction CI that falls under the preceding instruction category, the preceding expansion module 14 executes specific functions related to the control instruction CI. For example, in the situation where the preceding expansion module is a digital TV broadcast module, the specific functions include channel selection and volume tuning. In this regard, the succeeding expansion module operates in the same way as the preceding expansion module does.

After the preceding expansion module 14 and the succeeding expansion module 16 have received the control instruction CI from the master end 124, the preceding expansion module 14 determines whether the control instruction CI falls under the preceding instruction category, whereas the succeeding expansion module 16 determines whether the control instruction CI falls under the succeeding instruction category.

If the preceding expansion module 14 confirms that the control instruction CI falls under the preceding instruction category, the preceding expansion module 14 will generate a preceding data packet PDP in accordance with the control instruction CI. Conversely, if the preceding expansion module 14 confirms that the control instruction CI does not fall under the preceding instruction category, the preceding expansion module 14 will look forward to receiving an ensuing control instruction CI′.

If the succeeding expansion module 16 confirms that the control instruction CI falls under the succeeding instruction category, the succeeding expansion module 16 will generate a succeeding data packet SDP. Conversely, if the succeeding expansion module 16 confirms that the control instruction CI does not fall under the succeeding instruction category, the succeeding expansion module 16 will look forward to receiving the next control instruction CI′.

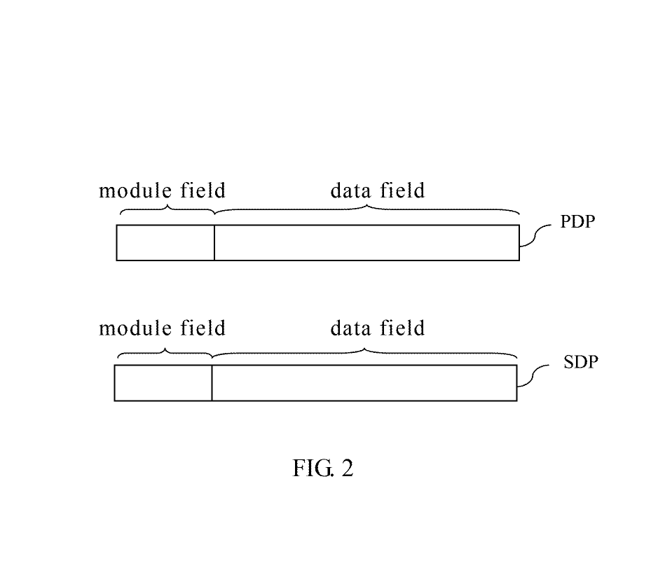

Referring to FIG. 2, there is shown a schematic view of the structure of the preceding data packet PDP and the succeeding data packet SDP. As regards their format, the preceding data packet PDP and the succeeding data packet SDP each comprise a module field and a data field. For example, the module field carries a modular ID whereby the master module 122 not only determines whether the preceding data packet PDP is generated by the preceding expansion module 14 but also determines whether the succeeding data packet SDP is generated by the succeeding expansion module 16. For example, the data field stores digital TV data, digital broadcast data, and multimedia data.

Referring to FIG. 1, for example, the master end 124 complies with the communication protocol governing an Ethernet, a Personal Computer Interface Express (PCI-E), or a Universal Serial Bus (USB). That is to say, as regards its type, the master end 124 is not limited by the aforesaid communication protocol; instead, a master end can function as the master end 124 of the present invention, provided that its electrical characteristics meet the requirement of the bandwidth required for simultaneous transmission of the preceding data packet PDP and the succeeding data packet SDP. For example, a bandwidth of 10M-100M bps is required for Ethernet-enabled data transmission, 5 Gbps for PCI-E-enabled data transmission, 480 Mbps for USB 2.0-enabled data transmission, and 4.8 Gbps for USB 3.0-enabled data transmission.

The preceding data packet PDP and the succeeding data packet SDP can carry digital TV data, digital broadcast data, and multimedia data. The contents of the data fields of the preceding data packet PDP and the succeeding data packet SDP depend on the functionality of the preceding expansion module 14 and the succeeding expansion module 16, that is, the type of the expansion modules. For example, the preceding expansion module 14 and the succeeding expansion module 16 are digital TV modules, digital broadcast modules, or hard disk drive modules.

For example, if both the preceding expansion module 14 and the succeeding expansion module 16 are digital TV modules, the data fields of the preceding data packet and the succeeding data packet contain digital TV data. Likewise, the contents of the data fields of digital broadcast modules and hard disk drive modules contain digital broadcast data and hard disk drive data, respectively.

In general, the master module 10 is disposed in a set-top box, for example. After the master module 10 has received the preceding data packet PDP and the succeeding data packet SDP, the master processing unit 122 of the master module 12 performs a digital signal processing procedure, such as decoding procedure, demodulation procedure, or decompression procedure, on the preceding data packet PDP and the succeeding data packet SDP, to enable users to watch videos or listen to audios.

The preceding expansion module 14 has a preceding end 142, a preceding processing unit 144, and a preceding expansion end 146. For example, the preceding expansion module 14 is a digital TV module, a digital broadcast module, or a hard disk drive module. The preceding end 142 is connected to the preceding processing unit 144 and the preceding expansion end 146. After the preceding processing unit 144 has received the control instruction CI, the preceding processing unit 144 determines whether the control instruction CI falls under the preceding instruction category. If the control instruction CI falls under the preceding instruction category, the preceding processing unit 144 will generate the preceding data packet PDP in accordance with the control instruction CI, and then the control instruction CI will be sent from the preceding end 142 to the master end 124. In this embodiment, the control instruction CI is sent from the master end 124 of the master module 12 to the preceding end 142 of the preceding expansion module 14. Then, the control instruction CI is sent from the preceding end 142 to the preceding processing unit 144 and the preceding expansion end 146.

The preceding end 142 and preceding expansion end 146 comply with the communication protocol governing the master end 124, such that the preceding end 142 can be readily connected to the master end 124, and the preceding expansion end 146 can be connected to the succeeding expansion module 16.

The preceding expansion end 146 not only sends the control instruction CI to the succeeding expansion module 16 but also sends the succeeding data packet SDP generated from the succeeding expansion module 16 to the preceding end 142, such that the preceding end 142 of the preceding expansion module 14 not only has the preceding data packet PDP generated from the preceding processing unit 144, but also has the succeeding data packet SDP generated from the succeeding expansion module 16.

The succeeding expansion module 16 comprises a succeeding end 162 and a succeeding processing unit 164. For example, the succeeding expansion module 16 is a digital TV module, a digital broadcast module, or a hard disk drive module. The succeeding end 142 complies with the communication protocol governing the preceding expansion end 146. The succeeding end 162 is connected to the succeeding processing unit 164 and the preceding expansion end 146. After the succeeding processing unit 164 has received the control instruction CI from the preceding expansion end 146, the succeeding processing unit 16 determines whether the control instruction CI falls under the succeeding instruction category. If the succeeding processing unit 16 confirms that the control instruction CI falls under the succeeding instruction category, the succeeding processing unit 164 will generate the succeeding data packet SDP in accordance with the control instruction CI, and the succeeding data packet SDP will be sent to the preceding expansion end 146 via the succeeding end 162, wherein the succeeding data packet SDP will be sent from the preceding expansion end 146 to the preceding end 142, such that the succeeding data packet SDP will be eventually sent to the master end 124.

This embodiment is exemplified by one said succeeding expansion module 16. In another embodiment, the succeeding expansion module 16 is provided in plurality. The plurality of succeeding expansion modules 16 operate in the same way as the preceding expansion module 14 and the succeeding expansion module 16 do. That is to say, the plurality of expansion modules operate in sequence pertaining to their electrical connection to thereby send a data packet generated from the final expansion module to the preceding expansion module.

Furthermore, in this embodiment, the succeeding expansion module 16 lacks any preceding expansion end similar to the preceding expansion end 146 of the preceding expansion module 14, such that the succeeding expansion module 16 is unable to be connected to another expansion module. Hence, the succeeding expansion module 16 may also be known as a terminal module, and the purpose of the terminal end module is to prevent electromagnetic interference (EMI) and thereby maintain or increase the rate of successful transmission of the preceding data packet PDP and the succeeding data packet SDP. For example, if the preceding expansion end 146 is not connected to another succeeding expansion module, it will be susceptible to EMI, and in consequence errors will be caused to the preceding data packet PDP and the succeeding data packet SDP.

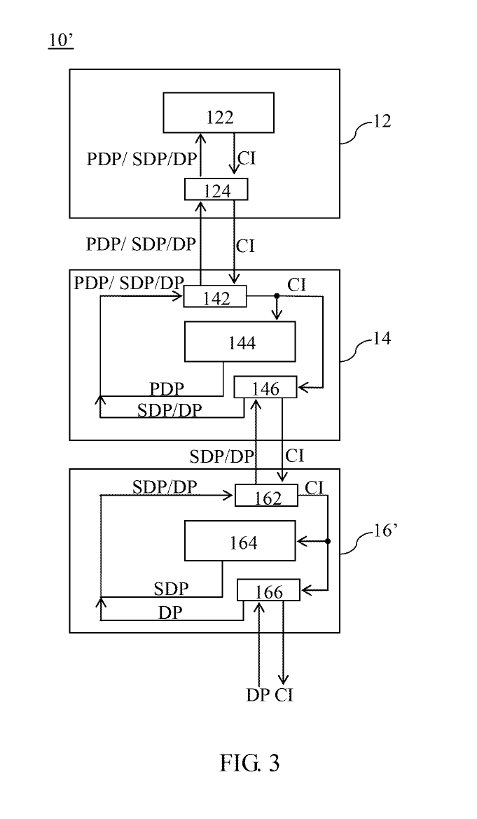

Referring to FIG. 3, there is shown a block diagram of a multistage module expansion system according to the second embodiment of the present invention. As shown in FIG. 3, a multistage module expansion system 10′ not only comprises the master module 12 and the preceding expansion module 14 which are disclosed in the first embodiment, but also comprises a succeeding expansion module 16′.

The succeeding expansion module 16′ comprises the succeeding end 162, the succeeding processing unit 164, and a succeeding expansion end 166. The succeeding end 162 is connected to the succeeding processing unit 164 and the succeeding expansion end 166. The succeeding end 162 receives the control instruction CI from the preceding expansion end 146, and the succeeding end 162 sends the control instruction CI to the succeeding processing unit 164 and the succeeding expansion end 166. After receiving the control instruction CI, the succeeding processing unit 164 determines whether the control instruction CI falls under a category of instructions executable by the succeeding processing unit 164. If the control instruction CI falls under the succeeding instruction category, the succeeding processing unit 164 will generate the succeeding data packet SDP, and the succeeding data packet SDP will be sent to the preceding expansion end 146 via the succeeding end 162.

The succeeding expansion end 166 is connected to another succeeding expansion module (not shown). The control instruction CI is sent to another succeeding expansion module via the succeeding expansion end 166. The succeeding expansion end 166 receives a data packet DP generated from another succeeding expansion module.

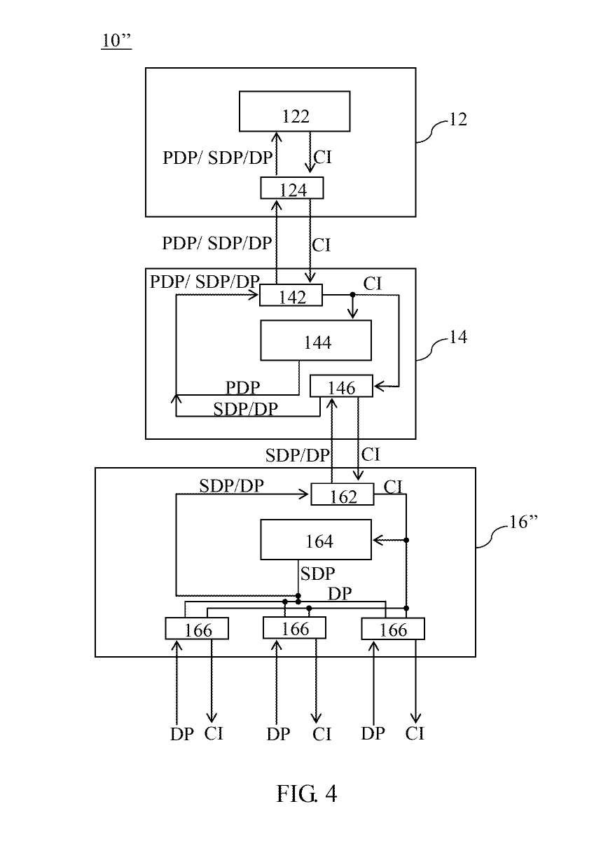

Referring to FIG. 4, there is shown a block diagram of the multistage module expansion system according to the third embodiment of the present invention. As shown in FIG. 4, a multistage module expansion system 10″ not only comprises the master module 12 and the preceding expansion module 14 which are disclosed in the second embodiment, but also comprises a succeeding expansion module 16″. The succeeding expansion module 16″ has multiple said succeeding expansion ends 166. The succeeding expansion ends 166 receive a plurality of data packets DP generated from multiple other expansion modules (not shown), and send the control instruction CI to another succeeding expansion module.

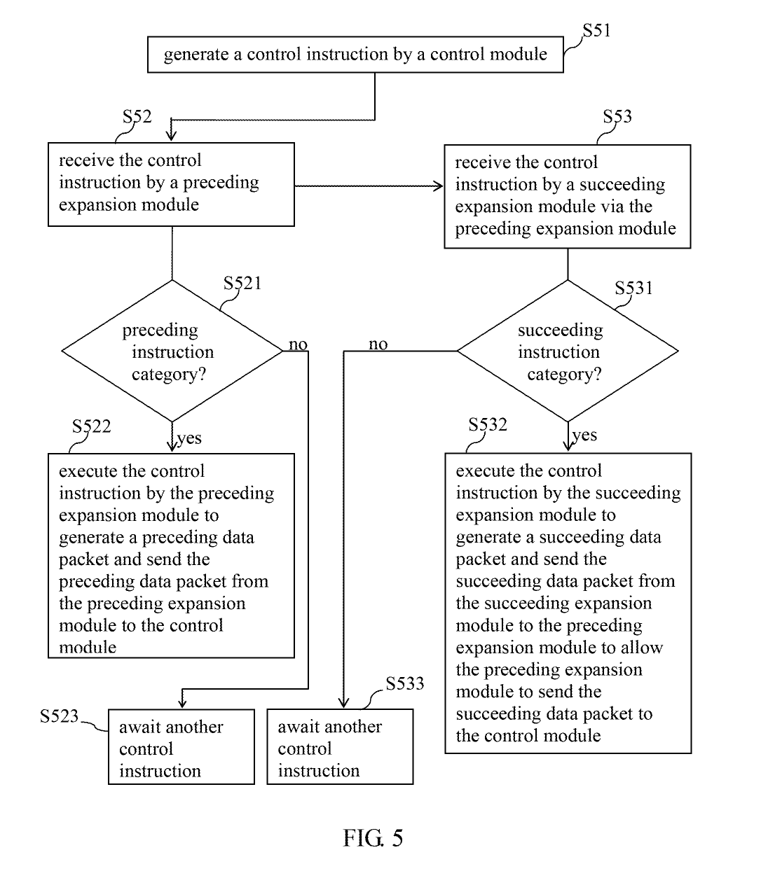

Referring to FIG. 5, there is shown a flow chart of a multistage module communication method according to an embodiment of the present invention. As shown in FIG. 5, the multistage module communication method allows a preceding data packet, a succeeding data packet, and a control instruction to be transmitted between a master module and at least a preceding expansion module, and allows the succeeding data packet and the control instruction to be transmitted between the at least a preceding expansion module and at least a succeeding expansion module.

The process flow of the multistage module communication method begins with step S51. In step S51, the master module generates the control instruction, wherein the control instruction falls under a category of instructions executable by the preceding expansion module (hereinafter referred to as “preceding instruction category”) or falls under a category of instructions executable by the succeeding expansion module (hereinafter referred to as “succeeding instruction category”).

In step S52, the preceding expansion module receives the control instruction. In step S53, the succeeding expansion module receives the control instruction via the preceding expansion module.

Step S52 is followed by step S521 in which the preceding expansion module determines whether the control instruction falls under the preceding instruction category. If the determination is affirmative, the process flow of the method will go to step S522; otherwise the process flow of the method will go to step S523.

In step S522, after confirming that the control instruction falls under the preceding instruction category, the preceding expansion module executes the control instruction and then generates and sends the preceding data packet to the master module.

In step S523, the preceding expansion module confirms that the control instruction does not fall under the preceding instruction category, and thus the preceding expansion module looks forward to receiving another control instruction.

Step S53 is followed by step S531 in which the succeeding expansion module determines whether the control instruction falls under the succeeding instruction category. If the determination is affirmative, the process flow of the method will go to step S532; otherwise the process flow of the method will go to step S533.

In step S532, the succeeding expansion module confirms that the control instruction falls under the succeeding instruction category, and thus the succeeding expansion module executes the control instruction, and then the succeeding expansion module generates and sends the succeeding data packet to the master module through the preceding expansion module.

In step S533, the succeeding expansion module confirms that the control instruction does not fall under the succeeding instruction category, and thus the succeeding expansion module looks forward to receiving another control instruction.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A multistage module expansion system, comprising:
a master module having a master processing unit and a master end connected to the master processing unit, the master processing unit generating a control instruction and sending the control instruction to the master end;
at least a preceding expansion module having a preceding end, a preceding processing unit, and a preceding expansion end, the preceding end being connected to the master end, the preceding processing unit, and the preceding expansion end, the preceding processing unit determining whether the control instruction falls under a category of instructions executable by the preceding processing unit, wherein, in response to an affirmative determination, the preceding processing unit executes the control instruction and generates a preceding data packet, such that the preceding processing unit sends the preceding data packet from the preceding end to the master end; and
at least a succeeding expansion module having a succeeding end and a succeeding processing unit, the succeeding end being connected to the succeeding processing unit and the preceding expansion end, the succeeding processing unit determining whether the control instruction falls under a category of instructions executable by the succeeding processing unit, wherein, in response to an affirmative determination, the succeeding processing unit executes the control instruction and generates a succeeding data packet, and the succeeding processing unit sends the succeeding data packet to the succeeding end, such that the succeeding data packet is sent to the master end via the preceding expansion end and the preceding end.

2. The multistage module expansion system of claim 1, wherein the at least a succeeding expansion module further comprises at least a succeeding expansion end connected to the succeeding end, such that the succeeding expansion module is connected to another succeeding expansion module via the succeeding expansion end.

3. The multistage module expansion system of claim 1, wherein the at least a succeeding expansion module further comprises a plurality of succeeding expansion ends and is connected to a plurality of other succeeding expansion modules via the succeeding expansion ends.

4. The multistage module expansion system of claim 1, wherein the at least a preceding expansion module is one of a digital TV module, a digital broadcast module, and a hard disk drive module, and the at least a succeeding expansion module is one of a digital TV module, a digital broadcast module, and a hard disk drive module.

5. The multistage module expansion system of claim 1, wherein the preceding data packet comprises a preceding module field and a preceding data field, and the succeeding data packet comprises a succeeding module field and a succeeding data field.

6. The multistage module expansion system of claim 1, wherein the master end, the preceding end, and the succeeding end conform to a communication protocol governing one of an Ethernet, a Personal Computer Interface Express, and a Universal Serial Bus.

7. A multistage module communication method for transmitting a preceding data packet, a succeeding data packet, and a control instruction between a master module and at least a preceding expansion module and transmitting the succeeding data packet and the control instruction between the at least a preceding expansion module and at least a succeeding expansion module, the multistage module communication method comprising the steps of:
(a) generating the control instruction by the master module, wherein the control instruction falls under a preceding instruction category executable by the preceding expansion module or a succeeding instruction category executable by the succeeding expansion module;
(b) receiving the control instruction by the preceding expansion module, and receiving the control instruction by the succeeding expansion module through the preceding expansion module;
(c) determining whether the control instruction falls under the preceding instruction category by the preceding expansion module and, upon affirmative determination, generating the preceding data packet by the preceding expansion module, and/or determining whether the control instruction falls under the succeeding instruction category and by the succeeding expansion module, upon affirmative determination, generating the succeeding data packet by the succeeding expansion module; and
(d) sending at least one of the preceding data packet and the succeeding data packet from the preceding expansion module to the master module, wherein the succeeding expansion module sends the succeeding data packet to the preceding expansion module to thereby allow the preceding expansion module to send the succeeding data packet to the master module.

8. The multistage module communication method of claim 7, wherein step (c) further includes the sub-step in which the preceding expansion module awaits another control instruction when the determination is negative, and the sub-step in which the succeeding expansion module awaits another control instruction when the determination is negative.

9. The multistage module communication method of claim 7, further comprising step (e) in which the master module analyzes the preceding data packet to confirm that the preceding data packet falls under the preceding expansion module and analyzes the succeeding data packet to confirm that the succeeding data packet falls under the succeeding expansion module.
